(19) United States
(12) Patent Application Publication
(10) Pub. No.: US 2004/0242318 A1
(43) Pub. Date: Dec. 2, 2004

(54) Gaming device and method having a repeating game cycle

(75) Inventors: Jerald C. Seelig, Absecon, NJ (US); Lawrence M. Henshaw, Hammonton, NJ (US)

Correspondence Address: IAN F. BURNS & ASSOCIATES, 1575 DELUCCHI LANE, SUITE 222, RENO, NV, 89502, US

(73) Assignee: AC Coin and Slot Service Company, Pleasantville, NJ

(21) Appl. No.: 10/881,531

(22) Filed: Jun. 30, 2004

Related U.S. Application Data
(63) Continuation-in-part of application No. 10/245,623, filed on Sep. 16, 2002.
Application No. 10/245,623 is a continuation-in-part of application No. 09/967,055, filed on Sep. 28, 2001.
(60) Provisional application No. 60/241,384, filed on Oct. 17, 2000.
(60) Provisional application No. 60/503,036, filed on Sep. 15, 2003.

(51) Int. Cl. A63F 13/00

(52) U.S. Cl. 463/20

(57) ABSTRACT

The present invention relates to a gaming device and a method of playing a game wherein a game cycle is repeated when a symbol selected by a player is substantially equivalent to a randomly selected symbol. More specifically, the gaming device includes one or more display devices configured to display a plurality of symbols and one or more input devices configured to allow a player to select at least one symbol from the plurality of symbols. One or more controllers also is provided in communication with the display device and the input device and is configured to detect the at least one symbol selected by the player, to randomly select at least one symbol from the plurality of symbols, to terminate the game cycle if a cycle terminating event has occurred, and to repeat, when appropriate, the game cycle if the at least one symbol selected by the player is substantially equivalent to the at least one randomly selected symbol.

### CROSS REFERENCE TO RELATED APPLICATIONS

This application is a continuation-in-part of U.S. patent application Ser. No. 10/245,623, filed Sep. 16, 2002, which is a continuation-in-part of U.S. patent application Ser. No. 09/967,055, filed Sep. 28, 2001. Application Ser. No. 09/967,055 claims priority to U.S. provisional patent application Ser. No. 60/241,384, filed Oct. 17, 2000 and entitled, “Gaming Bonus Device and Method of Use,” the contents of which are herein incorporated by reference. This application also claims priority to U.S. provisional patent application having Ser. No. 60/503,036, filed Sep. 15, 2003.

### BACKGROUND OF THE INVENTION

1. Field of the Invention

The present invention relates to gaming devices and to a method of playing a game. More particularly, the present invention relates to a gaming device and to a method of playing a game having a plurality of symbols and a repeating game cycle associated with the selection thereof.

2. Background

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number. The random number may then be compared to a predefined table to determine the outcome of the event. If the random number falls within a certain range of numbers on the table, the player may win a predefined prize. The table may also contain display information that allows the gaming device to generate a display that corresponds to the outcome of the game. The gaming device further may present the outcome of the game on a large variety of display devices, such as mechanical spinning reels or video screens.

Some gaming devices award bonuses in addition to prizes that are awarded in the primary game. A bonus can be defined as an additional prize that is awarded to the player when a predefined event occurs. An example of a bonus game can be found in U.S. Pat. No. 5,848,932 issued to Adams.

Players of gaming apparatus typically find it enjoyable to have a variety of different forms of gaming apparatus and/or a variety of different types of game play. Gaming machines that are more interesting generate more player excitement and in turn are played longer resulting in more revenue for the game operator. Generally, bonus prizes are offered in such games in order to increase the excitement and enjoyment experienced by players. This attracts more players to the game and encourages players to play longer. When gaming devices attract more players and the players play longer, the devices tend to be more commercially successful relative to other gaming devices.

In addition, highly visible display devices are utilized on gaming devices in order to attract players. Once players are attracted to the gaming device, they tend to play longer because the display device enhances the stimulation and excitement experienced by players. It is, therefore, desirable for gaming devices to incorporate highly visible display devices.

Display devices tend to be more successful if they are a derivation of a well-known game or theme. They are more successful because players tend to be drawn to games that they instantly recognize. Many players are reluctant to try completely new games because they must spend time to learn the new game. It is, therefore, desirable to provide display devices that are based on well-known games or themes.

Display devices also tend to be more successful if they utilize physical objects rather than simulations. Although video devices and electronic signs can be used for display devices, players are more attracted to display devices that utilize physical objects. Physical objects can be even more effective display devices if they are moveable and they are used in combination with lights and sounds. Jumbled ball displays are one type of display device utilized on gaming devices in order to attract players.

Notably, the similarity of gaming devices and methods of game play poses a problem for gaming manufacturers in differentiating their games from competitors. Providing an interesting and/or unique type of game play, can add differentiation to the game as well as more variety. A gaming device including a repeating game cycle would provide game players with a more exciting and desirable gaming experience. As such, the gaming device would attract more patrons to play the game and generate greater revenue for gaming operators. Accordingly, there exists an unmet need for providing a gaming device adapted to provide a repeating game cycle and for providing a method of playing a game having a plurality of symbols and a repeating game cycle associated with the selection thereof.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

provide longer play times and a greater payout possibility for a player;

provide greater revenues for gaming operators; and

provide a gaming device that utilizes a visually appealing and highly visible display device.

These and other advantages may be realized by reference to the remaining portions of the specification, claims, and abstract.

### Brief Description of One Embodiment of the Present Invention

The present invention generally comprises a gaming device including one or more display devices configured to display a plurality of symbols and one or more input devices configured to allow a player to select at least one symbol from the plurality of symbols. One or more controllers also is provided in communication with the display device and the input device, and is configured to detect the at least one symbol selected by the player, to randomly select at least one symbol from the plurality of symbols, to terminate the game cycle if a cycle terminating event has occurred, to repeat, when appropriate, the game cycle if the at least one symbol selected by the player is substantially equivalent to the at least one randomly selected symbol, and to award a prize to a player.

The present invention also provides a method of playing a repeating game cycle including providing a player with a plurality of symbols. The player then is allowed to select at least one symbol from the plurality of symbols. The next step includes randomly selecting at least one symbol from the plurality of symbols. If the at least one symbol selected by the player is substantially equivalent to the at least one randomly selected symbol, and it is determined that a terminating event has not occurred, the game cycle repeats. Otherwise, the game cycle ends and a prize may be awarded to the player.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is a front elevational view of one embodiment of the gaming device of the present invention.

FIG. 2 is a schematic representation of components of the gaming device of the present invention.

FIG. 3 is a flowchart of one method of game play of the present invention.

FIG. 4 is a flowchart of an alternative method of game play of the present invention.

FIG. 5 is a front elevational view of one embodiment of the display device of the present invention showing a plurality of symbols.

FIG. 6 is a front elevational view of the display device from FIG. 5 revealing a prize associated with each symbol.

### DESCRIPTION OF AN EMBODIMENT OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Gaming Device

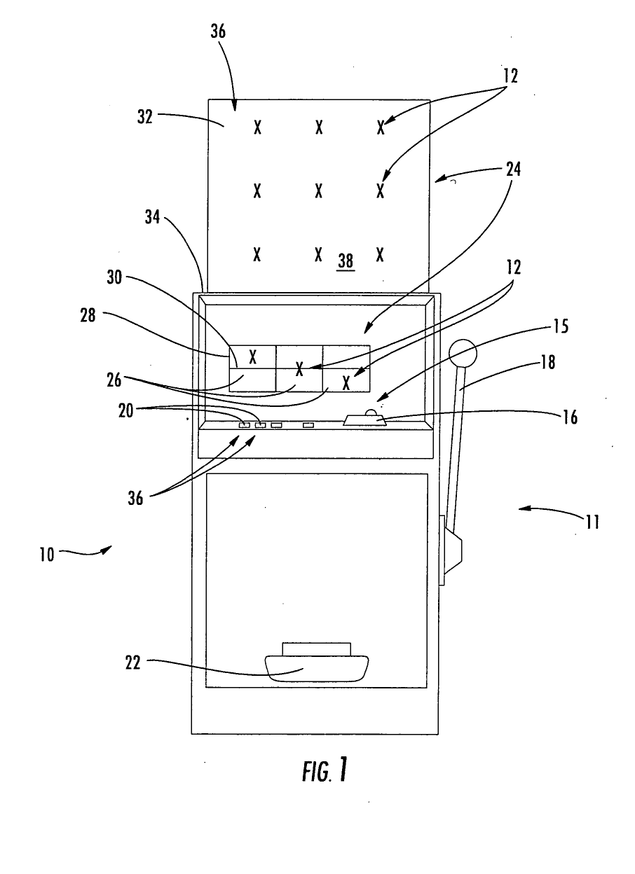

As shown in FIG. 1, the present invention generally comprises a gaming device 10 having a plurality of symbols 12, generally represented by “X”. The symbols 12 may include any letter, word, number, picture, image, and the like. Notably, gaming devices 10 may be any of a large number of devices 10 that are adapted to allow players (not shown) to play a game, such as those typically found in arcade and casino environments, including arcade games, video games, gambling machines, video poker machines, slot machines, etc. In this embodiment, the gaming device 10 represents a slot machine 11 which may have a value acceptor 15 for accepting value from a player, such as a coin slot 16, card reader (not shown), or a voucher reader (not shown). A handle 18 and/or a button(s) 20 also may be provided for activating the gaming device 10 to begin a game.

A payout mechanism (not shown) and a coin receptacle 22 may be provided for awarding prizes or for dispensing value to players cashing out and retiring from a game. A printer (not shown) may also be provided for printing out cashless vouchers. A pay table (not shown) may further be provided to allow a player to see what symbol 12 or combination of symbols 12 provide one or more winning events.

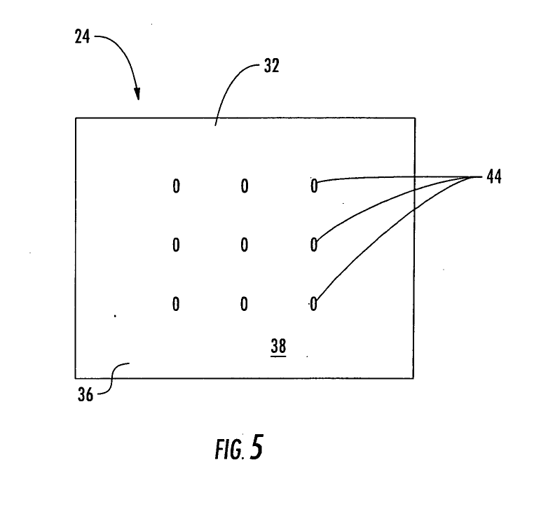

As further shown in FIG. 1, the gaming device 10 includes a display device 24 including a cathode ray tube, LCD, LED, plasma, and the like, configured to display at least one of the symbols 12 from the plurality of symbols 12. More specifically, the display device 24 can utilize physical game reels 26 which may be attached to a drive mechanism (not shown) to rotate the reels 26 in a manner well known in the art. Each game reel 26 may include a letter, word, number, picture, image, and the like, positioned on the circumference of each game reel 26. In a preferred embodiment, the symbols 12 are planets 44 (see FIG. 5), generically represented by circles. The planet 44 may be a picture or image of one or more fictional planets and/or representations of actual planets such as Mercury, Venus, Earth, Mars, Jupiter, Saturn, Uranus, Neptune, and/or Pluto.

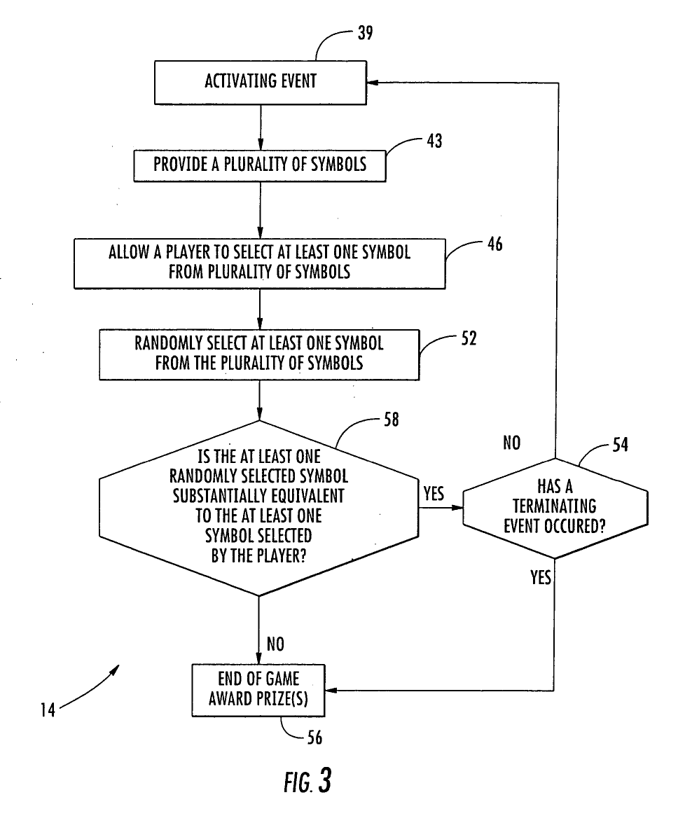

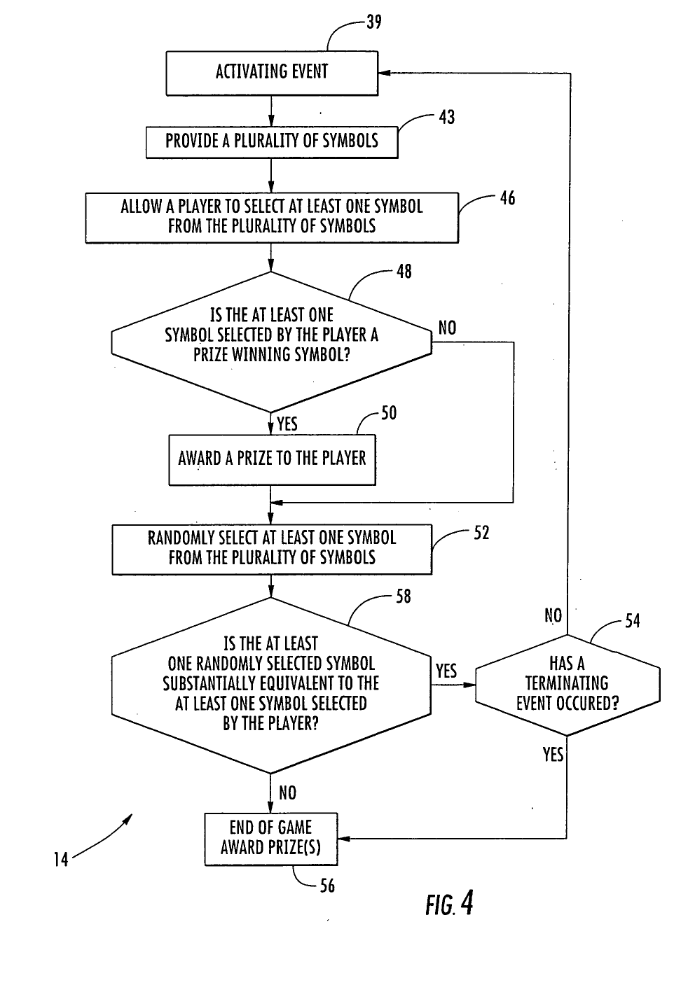

A panel 28 may cover the game reels 26 such that only a portion of their individual circumferences is shown to the player. At least one symbol 12 from any of the game reels 26 may be used to display a game outcome and/or activate a game cycle 14 (see FIGS. 3 and 4), preferably a bonus game cycle. At least one pay line 30 may be provided for the player to use in determining a game outcome based on the symbol 12 or combination of symbols 12 positioned thereon.

As further shown in FIG. 1, the display device 24 also may include a video display 32 displaying game symbols 12, i.e. letters, words, numbers, pictures, images, and the like, in any number of formats and arrangements. Alternatively, the video display 32 may display images of game reels 26 having symbols 12 and an image of at least one pay line 30. It is understood that the gaming device 10 may comprise more than one display device 24 such that the gaming device 10 could include physical game reels 26 and a video display 32, or any combination thereof. Accordingly, the display device 24, such as the video device 32, may be positioned at the top 34 of the gaming device 10, separate from the gaming device 10 but in communication therewith, or in communication with a plurality of different gaming devices 10 via a computer network in a manner that is well known in the art.

The present gaming device 10 further provides a repeating game cycle 14 (see FIGS. 3 and 4) associated with the selection of one or more symbols 12 from the plurality of symbols 12 displayed by the display device 24. The repeating game cycle 14 (FIGS. 3 and 4) preferably extends the length of play of a single game play and can be triggered by any number of activating events 39 (see FIGS. 3 and 4). This event may be many different types of events. For example, an activating event 39 (FIGS. 3 and 4) simply may include the placing of a wager (not shown) by the player or the displaying of a particular symbol 12 such as a number, letter, picture, and the like, or a combination thereof on one or more reels 26. The activating event 39 (FIGS. 3 and 4) also may be based on an external event.

The repeating game cycle 14 (see FIGS. 3 and 4) preferably is a bonus game wherein the player may be awarded a bonus prize. In the instance where the repeating game cycle 14 (FIGS. 3 and 4) includes a bonus game, a bonus activating event, during play of a primary game, triggers the gaming device 10 to allow a player to participate in the bonus game. The bonus activating event may include any one of the above mentioned activating events 39 (FIGS. 3 and 4) and further may include when a player accumulates a number of symbols 12 or game outcomes over a number of separate game plays.

As further shown in FIG. 1, the gaming device 10 includes an input device 36 such as a button(s) 20, a video touch screen(s) 38, and the like, which may be configured to allow a player to select one or more symbols 12 from the plurality of symbols 12 during a repeating game cycle 14 (FIGS. 3 and 4).

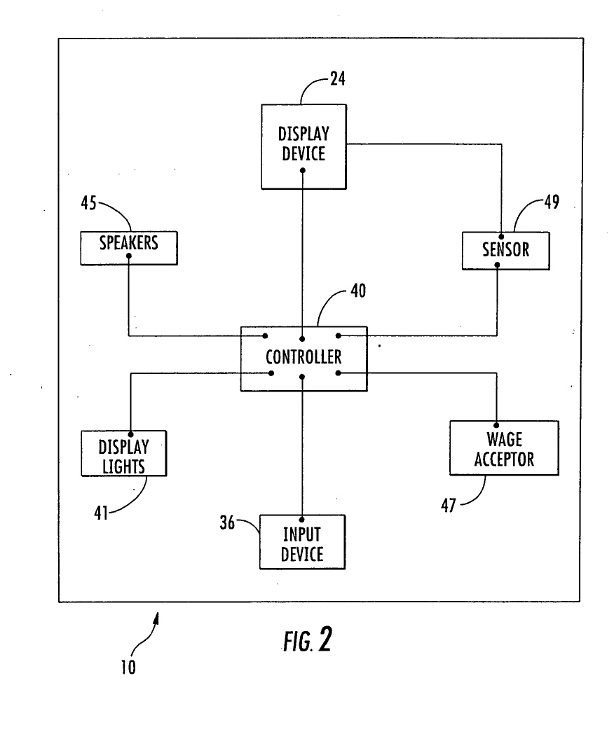

FIG. 2 shows the gaming device 10 including a controller 40. The controller is adapted to control the gaming device 10 by utilizing a random number generator (not shown) to produce random or pseudo random numbers for each game cycle 14 (FIGS. 3 and 4). The outcome of the repeating game cycle 14 (FIGS. 3 and 4) may be determined by comparing the random number to a table of outcomes stored in a memory (not shown) and accessed by the controller 40. A number of different tables of outcomes may be used and different tables may be used for different games. The tables can be designed so that different prizes have different probabilities of being awarded. Such design techniques are well known in the art. Examples of such designs are shown in U.S. Pat. No. 4,448,419, issued to Telnaes, and U.S. Pat. No. 5,456,465, issued to Durham. It is recognized that the gaming device 10 may operate in many other ways and still achieve the objects of the present invention.

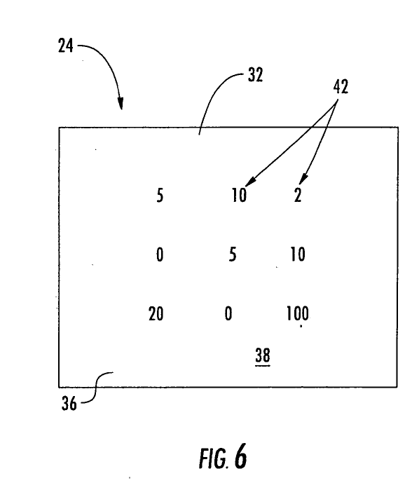

As further shown in FIG. 2, the controller 40 is provided in communication with the display device 24 and the input device 36 such that the controller is configured to detect the symbol(s) 12 selected by the player, to randomly select at least one symbol 12 from the plurality of symbols 12, to terminate the game cycle 14 (FIGS. 3 and 4) if a cycle terminating event has occurred, to repeat, when appropriate, the game cycle 14 (FIGS. 3 and 4) if the at least one symbol 12 selected by the player is substantially equivalent to the at least one symbol 12 randomly selected by the controller 40, and to award a prize to the player. The controller 40 may be one or more computers (not shown) or processor boards (not shown). The controller 40 preferably is further configured to associate at least one prize 42 (FIG. 6) with at least one of the plurality of symbols 12, i.e. a planet 44 (FIG. 5), and adapted to award the prize(s) 42 (FIG. 6) to the player. Also, the controller 40 generally is configured to communicate with a display light(s) 41 and a speaker(s) 45 for visual and sound effects.

The controller 40 also is adapted to generate and to detect when an activating event 39 (FIGS. 3 and 4), or bonus activating event, occurs for activation of the repeating game cycle 14 (FIGS. 3 and 4). For example, the controller 40 will determine which symbol(s) 12 of the plurality of symbols 12 to display to the player via the random number generator (not shown). Using a sensor(s) 49, the controller 40 then can detect and stop the reels 26 (FIG. 1) on the display device 24 when the symbol(s) are in the desired position. When reels 26 (FIG. 1) are in an activating event position, the controller 40 will sense this position and begin the repeating game cycle 14 (FIGS. 3 and 4). Sensors 49 may also be provided external to the gaming device 10 to detect external activating events. The controller 40 may also transmit and/or detect a variety of other information such as when coins (not shown) or currency (not shown) have been inserted into a wage acceptor 47, when a game starts, when an error has occurred, and when a sensor 49 detects tampering.

When the controller 40 detects an activating event 39 (see FIGS. 3 and 4), or bonus-activating event, it may begin the repeating game cycle 14 (FIGS. 3 and 4) by activating a video screen(s) 32 (FIG. 1), lights (41), light emitting diodes (not shown), etc. These display devices 24 (FIG. 1) may indicate that a player has qualified for the repeating game cycle 14 (FIGS. 3 and 4) and prompt the player to perform an action.

The gaming device 10 in FIG. 1 further may include a jumbled ball display (not shown) for cooperating with the gaming device 10 during the repeating game cycle 14 (FIGS. 3 and 4). A jumbled ball display (not shown) of the type described in U.S. patent application Ser. No. 09/535,075, filed on Mar. 23, 2000, is hereby incorporated herein by reference. Notably, the jumbled ball display (not shown) is a container (not shown) that is adapted to hold a plurality of display balls (not shown) which may be utilized in the repeating game cycle 14 (FIGS. 3 and 4). The balls (not shown) preferably are substantially equivalent to any symbol(s) 12 which would be displayed by the display device 24 for selection by the player during the repeating game cycle 14 (FIGS. 3 and 4). Accordingly, the jumbled ball display (not shown) may be replaced by a video display 32. A ball holder (not shown) preferably is used in conjunction with the jumbled ball display (not shown) and similarly is described in U.S. patent application Ser. No. 09/535,075, filed on Mar. 23, 2000 which is hereby incorporated herein by reference.

Method of Game Play

FIG. 3 illustrates one method of playing the gaming device 10 of the present invention wherein the repeating game cycle 14 is triggered by any number of activating events 39, which may include a bonus activating event. One such activating event 39 includes the displaying of a particular symbol(s) 12, such as letters, words, numbers, pictures, images, and the like, or a combination thereof, on one or more reels 26 of slot machine 11. The symbols 12 further may animate and the display device 24 may request the player to select one or more of the symbols 12. The symbol(s) 12 on the reels 26 or player selection of a particular symbol 12 may determine how many symbols 12 of a plurality of symbols 12 the player is allowed to select during the repeating game cycle 14.

After the occurrence of the activating event step 39, as shown in FIG. 3, play of the repeating game cycle 14, preferably a bonus game cycle, begins with step 43 wherein the display device 24, preferably a video display 32, provides a plurality of symbols 12. Again, the symbols 12 may include letters, words, numbers, pictures, images, and the like. In a preferred embodiment, as shown in FIG. 5, the symbols 12 are planets 44, generically represented by circles, with preferably nine different planet symbols arranged in three rows of three and displayed by the video display 32. It is understood that the planet symbol 44 may be an identifying letter(s), or word(s), and/or a picture, or image of one or more fictional planets and/or representations of yet unknown or known planets such as Mercury, Venus, Earth, Mars, Jupiter, Saturn, Uranus, Neptune, and/or Pluto.

As further shown in FIG. 3, the next step 46 allows a player to select one or more symbols 12, such as a planet symbol 44, from the plurality of symbols 12 using the input device 36, i.e. a touch screen 38, button(s) 20, and the like. Notably, the controller 40 is configured to detect the symbol(s) 12 selected since the controller 40 is in communication, as shown in FIG. 2, with the input device 36 as well as the display device 24. It is understood that the controller 40 may select the symbol(s) 12 if a designated amount of time elapses.

After the player is allowed to select one or more symbols 12, FIG. 4 shows optional step 48 wherein controller 40 determines whether the symbol(s) 12 selected by the player is a prize winning symbol. If the symbol 12 is a prize winning symbol, optional step 50 will award a prize 42 (FIG. 6) to the player.

As best shown in FIG. 6, the prize 42 is associated with one or more of the symbols 12, i.e. planets 44 (FIG. 5), such that the player may be shown and/or awarded the prize 42 by the gaming device 10 via the controller 40 after selection of the symbol(s) 12. The selected symbol(s) 12 further may be highlighted and any prize 42 associated with an unselected symbol also may be revealed.

As further shown in FIGS. 3 and 4, the controller in step 52 randomly selects at least one symbol 12, preferably one, from the plurality of symbols 12 with the assistance of the random number generator (not shown). It is noted that the symbol(s) 12 from which the controller 40 randomly selects may not be identical, but rather substantially equivalent, to the symbol(s) 12 from which the player is allowed to select. More specifically, the symbol(s) 12 that was allowed to be selected by the player may include a picture, image, and the like while the symbol(s) 12 randomly selected by the controller 40 may include a letter, word, and the like, or vice-versa. By way of specific example, a player may be allowed to select an image of Earth while the controller 40 may randomly select the word “Earth” such that the symbols 12 are substantially equivalent, yet not exactly the same. Once the controller 40 has selected one or more symbols 12, the symbol 12 preferably is displayed to the player via one or more of the display devices 24. In one embodiment, a jumbled ball display (not shown) is associated with the random selection of a symbol(s) 12 from the plurality of symbols 12 wherein a ball (not shown) having a symbol 12 thereon is randomly selected and shown to the player.

Next, in step 58, the controller 40 determines if the at least one symbol 12 selected by the player is substantially equivalent to the at least one symbol 12 randomly selected. If the at least one symbol 12 selected by the player is not substantially equivalent to the at least one symbol 12 selected by the controller 40, the game cycle ends with step 56 and a prize may be awarded to the player.

If the at least one symbol 12 selected by the player is substantially equivalent to the at least one symbol 12 selected by the controller 40, the controller 40 then considers, in step 54, whether any cycle terminating event has occurred. A cycle terminating event may include, but not be limited to, the occurrence of a predetermined number of cycles, may include the player having selected each of the plurality of symbols 12, may include the awarding of a prize to the player, and may include the total prizes awarded to the player being greater or equal to a predetermined amount.

If a terminating event has not occurred in step 54, the game cycle 14 repeats and begins again with step 43 by providing a plurality of symbols 12. However, if the controller 40, in step 54, determines that a cycle terminating event has occurred, the repeating game cycle 14 proceeds to step 56 such that the game ends. If the symbol(s) 12 randomly selected by the controller 40 matches the symbol(s) 12 that the player was allowed to select, the player also may receive a prize at the end of the game.

If any actual prize is money, the amount of the prize may be added to the player's credit meter (not shown) or the prize may be dispensed from, for example, the coin dispenser 22. Different kinds of prizes, besides monetary prizes, may be awarded. For example, the prizes may be goods, services, or additional games. The goods and services may be awarded in the form of physical objects, tickets, vouchers, coupons, etc. Additional games may be presented in the form of tickets, such as scratch-off lottery tickets. In the embodiments in which tickets, vouchers, or coupons are used, the objects are dispensed using an internally or externally mounted dispenser. Such dispensers are well known in the art.

It is understood that the repeating game cycle 14 may comprise a bonus game which may award a bonus prize to a player in addition to the prize awarded by a primary game. Also, a multiplier may be awarded to the player during the repeating game cycle 14 for multiplying the prize(s) awarded. All awards may be multiplied by the total wager.

### Conclusion

Accordingly, the present invention provides a gaming device 10 having a plurality of symbols 12 and a repeating game cycle 14 associated with the selection thereof. Not only is the repeating game cycle 14 exciting and enjoyable to play, it also increases the length of play experienced by players as well as offers a potential for additional prizes during a single game play.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than solely by the examples given.

What is claimed is:

1. A method of playing a game cycle comprising, not necessarily in the order shown:
(A) providing a plurality of symbols;
(B) allowing a player to select at least one symbol from the plurality of symbols;
(C) randomly selecting at least one symbol from the plurality of symbols;
(D) if the at least one symbol selected by the player is substantially equivalent to the at least one randomly selected symbol and a cycle terminating event has not occurred, repeating steps (A) through (D); and
(E) terminating the game cycle.

2. The method of playing a game cycle as recited in claim 1 wherein the cycle terminating event includes occurrence of a predetermined number of cycles.

3. The method of playing a game cycle as recited in claim 1 further comprising awarding a prize to the player, wherein the cycle terminating event includes the total prizes awarded to the player being greater than or equal to a predetermined amount.

4. The method of playing a game cycle as recited in claim 1 wherein the game cycle is a bonus game.

5. The method of playing a game cycle as recited in claim 1 wherein the cycle terminating event includes the player having selected each of the plurality of symbols.

6. The method of playing a game cycle as recited in claim 1 further comprising, if the at least one randomly selected symbol is substantially equivalent to the at least one symbol selected by the player, awarding a prize to the player.

7. The method of playing a game cycle as recited in claim 1 further comprising allowing a player to place a wager.

8. The method of playing a game cycle as recited in claim 1 wherein steps (A) through (D) are repeated if the at least one symbol selected by the player is the same as the at least one randomly selected symbol.

9. The method of playing a game cycle as recited in claim 1 further comprising associating at least one prize with at least one of the plurality of symbols and awarding the at least one prize to the player.

10. The method of playing a game cycle as recited in claim 9 wherein the at least one prize associated with the at least one of the plurality of symbols is not revealed to the player until after the player has selected the at least one symbol.

11. The method of playing a game cycle as recited in claim 9 further comprising associating a prize with each of the plurality of symbols.

12. A method of playing a game cycle comprising, not necessarily in the order shown:
(A) providing a plurality of symbols;
(B) allowing a player to select at least one symbol from the plurality of symbols;
(C) awarding a prize to the player;
(D) randomly selecting at least one symbol from the plurality of symbols;
(E) if the at least one symbol selected by the player is substantially equivalent to the at least one randomly selected symbol and a cycle terminating event has not occurred, repeating steps (A) through (E); and
(F) terminating the game cycle.

13. The method of playing a game cycle as recited in claim 12 wherein the cycle terminating event includes occurrence of a predetermined number of cycles.

14. The method of playing a game cycle as recited in claim 12 wherein the cycle terminating event includes the total prizes awarded to the player being equal to or greater than a predetermined amount.

15. The method of playing a game cycle as recited in claim 12 wherein the game cycle is a bonus game.

16. The method of playing a game cycle as recited in claim 12 wherein the cycle terminating event includes the player having selected each of the plurality of symbols.

17. The method of playing a game cycle as recited in claim 12 further comprising, if the at least one symbol selected by the player comprises the at least one randomly selected symbol, awarding a second prize to the player.

18. The method of playing a game cycle as recited in claim 12 further comprising allowing a player to place a wager.

19. The method of playing a game cycle as recited in claim 12 wherein steps (A) through (E) are repeated if the at least one symbol selected by the player is the same as the at least one randomly selected symbol.

20. The method of playing a game cycle as recited in claim 12 further comprising associating at least one prize with at least one of the plurality of symbols and awarding the at least one prize to the player.

21. The method of playing a game cycle as recited in claim 20 wherein the at least one prize associated with the at least one of the plurality of symbols is not revealed to the player until after the player has selected the at least one symbol.

22. The method of playing a game cycle as recited in claim 20 further comprising associating a prize with each of the plurality of symbols.

23. A gaming device for playing a game cycle comprising:
(A) display means for displaying a plurality of symbols;
(B) input means for allowing a player to select at least one symbol from the plurality of symbols;
(C) selection means for randomly selecting at least one symbol from the plurality of symbols;
(D) repeating means for repeating the game cycle if the at least one symbol selected by the player is substantially equivalent to the at least one symbol selected by the selection means and if a cycle terminating event has not occurred; and
(E) terminating means for terminating the game cycle.

24. The gaming device as recited in claim 23 wherein the cycle terminating event includes occurrence of a predetermined number of cycles.

25. The gaming device as recited in claim 23 wherein the cycle terminating event includes the total prizes awarded to the player being greater than a predetermined amount.

26. The gaming device as recited in claim 23 wherein the game cycle is a bonus game.

27. The gaming device as recited in claim 23 wherein the cycle terminating event includes the player having selected each of the plurality of symbols.

28. The gaming device as recited in claim 23 further comprising award means for awarding a prize to the player if the at least one symbol selected by the player is substantially equivalent to the at least one symbol selected by the selection means.

29. The gaming device as recited in claim 23 further comprising a means for receiving a wager.

30. The gaming device as recited in claim 23 wherein the game cycle repeats if the at least one symbol selected by the player is the same as the at least one randomly selected symbol.

31. The gaming device as recited in claim 23 further comprising associating means for associating at least one prize with at least one of the plurality of symbols and awarding the at least one prize to the player.

32. The gaming device as recited in claim 31 wherein the at least one prize associated with the at least one of the plurality of symbols is not revealed to the player until after the player has selected the at least one symbol.

33. The gaming device as recited in claim 31 further comprising associating a prize with each of the plurality of symbols.

34. A gaming device for playing a game cycle comprising:
(A) at least one display device configured to display a plurality of symbols;
(B) at least one input device configured to allow a player to select at least one symbol from the plurality of symbols;
(C) at least one controller in communication with the display device and the input device, the controller being configured to:
(a) detect the symbol selected by the player;
(b) randomly select at least one symbol from the plurality of symbols;
(c) repeat the game cycle if the at least one symbol selected by the player is substantially equivalent to the at least one randomly selected symbol and a cycle terminating event has not occurred; and
(d) terminate the game cycle.

35. The gaming device as recited in claim 34 wherein the cycle terminating event includes occurrence of a predetermined number of cycles.

36. The gaming device as recited in claim 34 wherein the display device further includes displaying a prize to the player, wherein the cycle terminating event includes the total prizes awarded to the player being greater than a predetermined amount.

37. The gaming device as recited in claim 34 wherein the game cycle is a bonus game.

38. The gaming device as recited in claim 34 wherein the cycle terminating event includes the player having selected each of the plurality of symbols.

39. The gaming device as recited in claim 34 wherein the controller is further configured to award a prize to the player if the at least one symbol selected by the player is substantially equivalent to the at least one randomly selected symbol.

40. The gaming device as recited in claim 34 wherein the controller is further configured to associate at least one prize with at least one of the plurality of symbols and award the at least one prize to the player.

41. The gaming device as recited in claim 40 wherein the at least one prize associated with the at least one of the plurality of symbols is not revealed to the player until after the player has selected the at least one symbol.

42. The gaming device as recited in claim 40 wherein the controller is configured to associate a prize with each of the plurality of symbols.
